(19) United States
(12) Patent Application Publication
(10) Pub. No.: US 2019/0066186 A1
(43) Pub. Date: Feb. 28, 2019

(54) CROSS DOMAIN RECOMMENDATION SYSTEM AND METHOD

(71) Applicant: Artivatic Data Labs Private Limited, Bangalore (IN)

(72) Inventors: Layak SINGH, Dayalbagh (IN); Puneet TANDON, Bangalore (IN); Soham DUTTA, Bangalore (IN); Tushar SHARMA, Bangalore (IN); Awadhesh SHARMA, Bangalore (IN); Shikha CHAURASIA, Bangalore (IN); Omkar DHARIYA, Bangalore (IN)

(21) Appl. No.: 15/825,006

(22) Filed: Nov. 28, 2017

(30) Foreign Application Priority Data
Aug. 24, 2017 (IN) 201741030055

(51) Int. Cl. G06Q 30/06; G06F 15/18; G06F 17/30; G06F 17/27

(52) U.S. Cl. CPC G06Q 30/0631; G06F 17/27; G06F 17/30598; G06F 15/18

(57) ABSTRACT

The present disclosure provides a cross domain recommendation system. The cross domain recommendation system recommends at least one entity of one or more entities to the one or more entities in a new domain based on the interaction of the one or more entities in a plurality of domains. The cross domain recommendation system collects a first set of data and a second set of data. In addition, the cross domain recommendation system creates an entity model for each of the one or more entities in real time. The cross domain recommendation system analyzes the first set of data and the second set of data. Further, the cross domain recommendation system builds the one or more clusters. Furthermore, the cross domain recommendation system ranks the one or more entities. The cross domain recommendation system recommends the at least one entity to the one or more entities in the new domain.

### TECHNICAL FIELD

The present invention relates to the field of recommendation system. More specifically relates to a method and system for cross domain recommendation of one or more entities to an entity in a targeted domain by using one or more profiles from other known domains.

### BACKGROUND

With the advent of technological advancements in the last few years, a handful number of portable communication devices are available in the market. These portable communication devices allow users browse through the internet for viewing numerous products of their choice on various online publishers. For example, a user may be looking for a new smart phone or another user may be interested in buying footwear or apparels. Also, these online publishers employ various technologies to gain access to a wide range of information available from these users who access their online portals. In addition, the information is being utilized for targeting users looking to buy products on publisher websites.

The entities may belong to a different category of actors or domain of actors. In addition, the entities may be looking at various online services provided by various actors. The entity may be view one or more entities associated with a specific domain of actors. Nowadays, the online publishers utilize the information related to one or more entities viewed by the entities in each type of domain. These online publishers utilize various recommendation systems for targeting entities with entities from a domain of actors with which the entity have recently interacted. These recommendation systems are capable of targeting the entities for showing advertisements related to the other entities of the interests of the calling entity. Further, each entity is looking for a different type of attributes in entities while browsing on the publisher website. The current recommendation systems utilize this information and recommend one or more entities having similar attributes to the entities of interest of the calling entity. However, these recommendation systems do not recommends entities from other domains based on interaction of the calling entities with a particular domain. In addition, these recommendation systems are not able to perform highly accurate recommendations from a new domain based on interaction with one or more domains.

In light of the above stated discussion, there is a need for a system which overcomes the above stated disadvantages.

### SUMMARY

In a first example, the present disclosure provides a computer implemented method. The computer implemented method provides a recommendation of at least one entity of one or more entities to another entity of the one or more entities in a new domain by using one or more profiles from a plurality of domains. The method may include a first step of collecting a first set of data and a second set of data associated with the one or more entities. In addition, the method may include a second step of creating an entity model for each of the one or more entities in real time. Further, the method may include a third step of analyzing the first set of data and the second set of data associated with the one or more entities in real time. Moreover, the method may include a fourth step of classifying each of the one or more entities in one or more clusters based on the analysis of the first set of data and the second set of data. The first set of data and the second set of data are associated with the one or more entities. Furthermore, the method may include a fifth step of ranking the one or more entities in each cluster of the one or more clusters. The ranking is based on a calculated distance between one or more values associated with the entity model and one more feature value associated with the one or more entities. In addition, the ranking of the one or more entities in each cluster of the one or more clusters based on one or more mapped features of the one or more entities with the one or more entity preferences of the one or more entities. Furthermore, the ranking of the one or more entities in each cluster of the one or more clusters is done based on the correlation of the one or more entities with other one or more entities. Also, the method may include a sixth step of recommendation of at least one entity associated with at least one domain of the plurality of domains to the one or more entities based on the ranking. The first set of data includes demographic information of the one or more entities. The second set of data includes information associated with the interaction between the at least one entity of the one or more entities with another entity of the one or more entities. The first set of data and the second set of data are collected in real time. The entity model of the one or more entities is created based on the first set of data and the second set of data associated with the one or more entities. The entity model is created for defining a set of activities performed by each of the one or more entities based on the interaction between the one or more entities. The analyzing is done using one or more techniques and machine learning algorithm. The analyzing is done to determine a correlation in the one or more entities and one or more entity preferences associated with the one or more entities in each of the plurality of domain. The one or more clusters of the one or more entities are created in real time by using one or more clustering techniques. The ranking is done in real time. At least one entity recommended to the one or more entities is associated with the at least one domain different than on or more domains with which the one or more entities interacted in real time. The recommendation of the at least one entity to the one or more entities is done based on a request by an entity of the one or more entities for receiving recommendation for at least one other entity of the one or more entities.

In an embodiment of present disclosure, the computer-implemented method may include another step of storing the first set of data, the second set of data, and the entity model of the one or more entities. In addition, the computer-implemented method may store the one or more clusters of the one or more entities and common features value, the recommended entity and the common feature value as the model of the one or more entities.

In an embodiment of present disclosure, the computer-implemented method may include yet another step of updating the first set of data, the second set of data, and the entity model of the one or more entities. In addition, the computer-implemented method may update the one or more clusters of the one or more entities and common features value, the recommended entity and the common feature value as the model of the one or more entities.

In an embodiment of the present disclosure, the entity includes at least one of one or more e-services, one or more products, one or more entity and one or more businesses.

In an embodiment of the present disclosure, the first set of data includes name, age, gender, address, contact number, e-mail address, qualification and preferences of the one or more entities in one or more domains.

In an embodiment of the present disclosure, the second set of data includes one or more entity purchase histories, entity viewing histories, entity ratings, entity reviews, entity subscribed and entity downloads.

In an embodiment of the present disclosure, the one or more techniques includes natural language processing technique to analyze the reviews, tokenization techniques to extract the information and machine learning algorithms.

In an embodiment of the present disclosure, the cluster of the one or more entities is created with one or more features of the one or more entities with which the one or more entities interact.

In a second example, the present disclosure provides a computer system. The computer system may include one or more processors. In addition, the computer system may include a memory coupled to the one or more processors. The memory may store instructions which when executed by the one or more processors, cause the one or more processors to perform a method. The method provides a recommendation of at least one entity of one or more entities to another entity of the one or more entities in a new domain by using one or more profiles from a plurality of domains. The method may include a first step of collecting a first set of data and a second set of data associated with the one or more entities. In addition, the method may include a second step of creating an entity model for each of the one or more entities in real time. Further, the method may include a third step of analyzing the first set of data and the second set of data associated with the one or more entities in real time. Moreover, the method may include a fourth step of classifying each of the one or more entities in one or more clusters based on the analysis of the first set of data and the second set of data. The first set of data and the second set of data are associated with the one or more entities. Furthermore, the method may include a fifth step of ranking the one or more entities in each cluster of the one or more clusters. The ranking is based on a calculated distance between one or more values associated with the entity model and one more feature value associated with the one or more entities. In addition, the ranking of the one or more entities in each cluster of the one or more clusters based on one or more mapped features of the one or more entities with the one or more entity preferences of the one or more entities. Furthermore, the ranking of the one or more entities in each cluster of the one or more clusters is done based on the correlation of the one or more entities with other one or more entities. Also, the method may include a sixth step of recommendation of at least one entity associated with at least one domain of the plurality of domains to the one or more entities based on the ranking. The first set of data includes demographic information of the one or more entities. The second set of data includes information associated with the interaction between the at least one entity of the one or more entities with another entity of the one or more entities. The first set of data and the second set of data are collected in real time. The entity model of the one or more entities is created based on the first set of data and the second set of data associated with the one or more entities. The entity model is created for defining a set of activities performed by each of the one or more entities based on the interaction between the one or more entities. The analyzing is done using one or more techniques and machine learning algorithm. The analyzing is done to determine a correlation in the one or more entities and one or more entity preferences associated with the one or more entities in each of the plurality of domain. The one or more clusters of the one or more entities are created in real time by using one or more clustering techniques. The ranking is done in real time. At least one entity recommended to the one or more entities is associated with the at least one domain different than on or more domains with which the one or more entities interacted in real time. The recommendation of the at least one entity to the one or more entities is done based on a request by an entity of the one or more entities for receiving recommendation for at least one other entity of the one or more entities.

In a third example, a computer-readable storage medium is provided. The computer-readable storage medium encodes computer executable instructions that, when executed by at least one processor, performs a method. The method provides a recommendation of at least one entity of one or more entities to another entity of the one or more entities in a new domain by using one or more profiles from a plurality of domains. The method may include a first step of collecting a first set of data and a second set of data associated with the one or more entities. In addition, the method may include a second step of creating an entity model for each of the one or more entities in real time. Further, the method may include a third step of analyzing the first set of data and the second set of data associated with the one or more entities in real time. Moreover, the method may include a fourth step of classifying each of the one or more entities in one or more clusters based on the analysis of the first set of data and the second set of data. The first set of data and the second set of data are associated with the one or more entities. Furthermore, the method may include a fifth step of ranking the one or more entities in each cluster of the one or more clusters. The ranking is based on a calculated distance between one or more values associated with the entity model and one more feature value associated with the one or more entities. In addition, the ranking of the one or more entities in each cluster of the one or more clusters based on one or more mapped features of the one or more entities with the one or more entity preferences of the one or more entities. Furthermore, the ranking of the one or more entities in each cluster of the one or more clusters is done based on the correlation of the one or more entities with other one or more entities. Also, the method may include a sixth step of recommendation of at least one entity associated with at least one domain of the plurality of domains to the one or more entities based on the ranking. The first set of data includes demographic information of the one or more entities. The second set of data includes information associated with the interaction between the at least one entity of the one or more entities with another entity of the one or more entities. The first set of data and the second set of data are collected in real time. The entity model of the one or more entities is created based on the first set of data and the second set of data associated with the one or more entities. The entity model is created for defining a set of activities performed by each of the one or more entities based on the interaction between the one or more entities. The analyzing is done using one or more techniques and machine learning algorithm. The analyzing is done to determine a correlation in the one or more entities and one or more entity preferences associated with the one or more entities in each of the plurality of domain. The one or more clusters of the one or more entities are created in real time by using one or more clustering techniques. The ranking is done in real time. At least one entity recommended to the one or more entities is associated with the at least one domain different than on or more domains with which the one or more entities interacted in real time. The recommendation of the at least one entity to the one or more entities is done based on a request by an entity of the one or more entities for receiving recommendation for at least one other entity of the one or more entities.

### BRIEF DESCRIPTION OF THE FIGURES

Having thus described the invention in general terms, reference will now be made to the accompanying drawings, which are not necessarily drawn to scale, and wherein:

FIG. 1 illustrates a general overview of a system for real time recommendation of one or more entities to one or more entities in a new domain, in accordance with various embodiments of the present disclosure;

FIG. 2 illustrates a block diagram of a cross domain recommendation system, in accordance with various embodiments of the present disclosure;

FIG. 3 illustrates a flow chart for real time recommendation of the one or more entities to the one or more entities in one or more domains, in accordance with various embodiments of the present disclosure; and

FIG. 4 illustrates a block diagram of a computing device, in accordance with various embodiments of the present disclosure.

It should be noted that the accompanying figures are intended to present illustrations of exemplary embodiments of the present invention. These figures are not intended to limit the scope of the present invention. It should also be noted that accompanying figures are not necessarily drawn to scale.

### DETAILED DESCRIPTION

Reference will now be made in detail to selected embodiments of the present disclosure in conjunction with accompanying figures. The embodiments described herein are not intended to limit the scope of the disclosure, and the present disclosure should not be construed as limited to the embodiments described. This disclosure may be embodied in different forms without departing from the scope and spirit of the disclosure. It should be understood that the accompanying figures are intended and provided to illustrate embodiments of the disclosure described below and are not necessarily drawn to scale. In the drawings, like numbers refer to like elements throughout, and thicknesses and dimensions of some components may be exaggerated for providing better clarity and ease of understanding.

It should be noted that the terms “first”, “second”, and the like, herein do not denote any order, ranking, quantity, or importance, but rather are used to distinguish one element from another. Further, the terms “a” and “an” herein do not denote a limitation of quantity, but rather denote the presence of at least one of the referenced item.

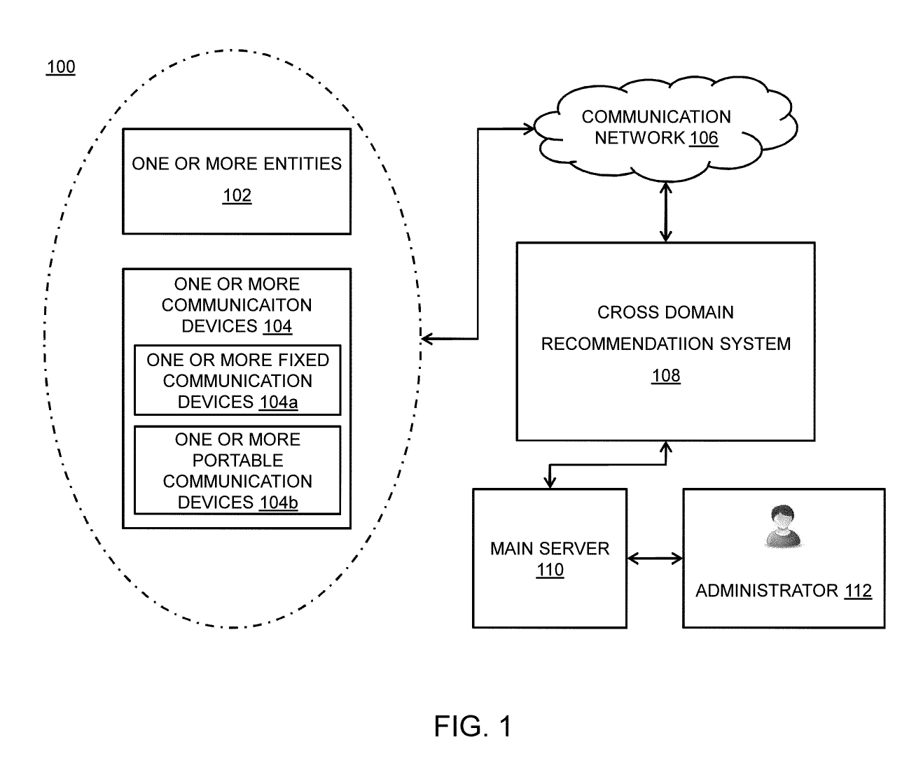

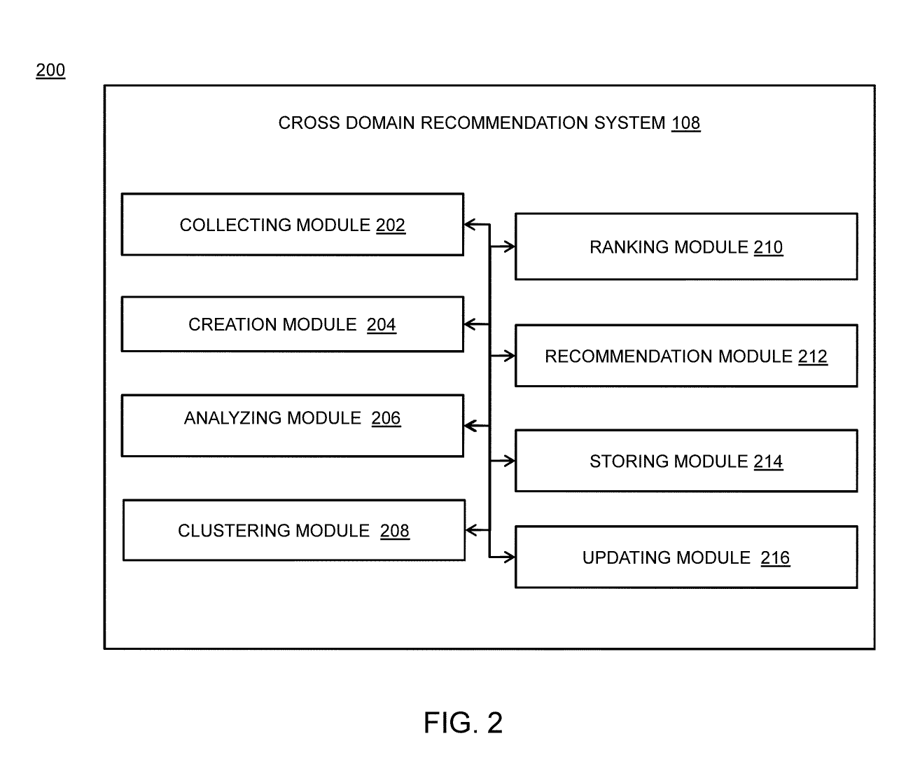

FIG. 1A illustrates a general overview of a system 100 for real time recommendation of one or more entities 102 to the one or more entities 102 in a targeted domain. The recommendation of the one or more entities 102 is done by using one or more profiles from a plurality of domains, in accordance with various embodiments of the present disclosure. The system 100 performs recommendation of the one or more entities 102 in the targeted domain to the one or more entities 102 in real time. In addition, the system 100 performs the recommendation of the one or more entities 102 in a new domain based on the profile of the one or more entities 102 in the plurality of domains (explained below in the detailed description of FIG. 2). Moreover, the system 100 recommends the one or more entities 102 to the new entity by using profile of the one or more similar entities. Further, the system 100 utilizes real time machine learning algorithms for the recommendation of the one or more entities 102. Furthermore, the system 100 utilizes clustering technique to build the one or more clusters of the one or more entities 102.

Going further, the system 100 includes one or more communication devices 104, a communication network 106, a cross domain recommendation system 108, and a main server 110. The above stated elements of the system 100 collectively enable recommendation of the one or more entities 102 to the one or more entities 102 in the targeted domain. The one or more communication devices 104 are associated with the one or more entities 102. The one or more entities 102 located in any environment. In an example the environment includes but may not be limited to any place, venue, indoor location, outdoor location and the like.

In an embodiment of the present disclosure, the one or more entities 102 may include one or more users, one or more businesses, one or more products, and one or more devices. In addition, the one or more entities 102 may include one or more e-services, one or more clients, one or more entity, one or more publishers and the like.

The one or more entities 102 may be any person or individual looking to buy the one or more entities 102 in real time. In addition, the one or more entities 102 may be any person or individual who wants the recommendation of the one or more entities 102. Moreover, the one or more entities 102 may be any person or individual who is looking to buy new one or more entities 102 in an unfamiliar domain. The one or more entities 102 are associated with the one or more communication devices 104. The one or more entities 102 are the owner of each of the one or more communication devices 104. In an embodiment of the present disclosure, the one or more entities 102 may not be the owner of each of the one or more communication devices 104.

In an example, the one or more communication devices 104 includes but may not be limited to a laptop, personal computer, smartphone, and tablet. Moreover, the one or more communication devices 104 include one or more fixed communication devices 104a and one or more portable communication devices 104b. The one or more fixed communication devices 104a are fixed at one place inside the environment. The one or more fixed communication devices 104a are operable inside any environment only due to constant need of electricity. The one or more fixed communication devices 104a includes personal computer, Smart television. The one or more portable communication devices 104b can be moved from one place to another and inside and outside of the environment. The one or more portable communication devices 104b include laptop, tablet and smart phone.

The one or more communication devices 104 are connected to the internet in real time. Further, the one or more communication devices 104 are associated with a specific type of operating system. The specific type of operating system includes an android operating system, a windows operating system, a mac operating system and the like. Moreover, the one or more communication devices 104 are connected to the internet through the communication network 106. Further, the one or more communication devices 104 are connected to the internet through a data connection provided by a telecom service provider. The telecom service provider is associated with a subscriber identification module card located inside the portable communication device. Furthermore, the one or more communication devices 104 may be connected to the internet through a WiFi connection.

The one or more communication devices 104 are associated with the cross domain recommendation system 108. In addition, the one or more communication devices 104 are associated with the cross domain recommendation system 108 through the communication network 106. In an embodiment of the present disclosure, the communication network 106 enables the one or more communication devices 104 to gain access to the internet. Moreover, the communication network 106 provides a medium for transfer of information between the one or more communication devices 104 and the cross domain recommendation system 108.

Further, the medium for communication may be infrared, microwave, radio frequency (RF) and the like. The communication network 106 includes but may not be limited to a local area network, a metropolitan area network, a wide area network, a virtual private network. In addition, the communication network 106 includes but may not be limited to a global area network, a home area network or any other communication network presently known in the art. The communication network 106 is a structure of various nodes or communication devices connected to each other through a network topology method. Examples of the network topology include a bus topology, a star topology, a mesh topology and the like.

The cross domain recommendation system 108 is a platform for real time recommendation of the one or more entities 102 to the one or more entities 102 in the targeted domain. The recommendation of the one or more entities 102 is done by using the profile of the one or more entities 102 from the plurality of domains. In addition, the cross domain recommendation system 108 performs the recommendation based on the entity model (mentioned in detail below in the patent application). In an embodiment of the present disclosure, the recommendation of the one or more entities 102 to the one or more entities 102 is from the new domain based on the interaction with the plurality of domains. The recommendation of the one or more entities 102 from the new domain is based on the attribute of the one or more entities 102 in the plurality of domains. Furthermore, the cross domain recommendation system 108 recommends the one or more entities 102 to the one or more entities 102 in the new domain based on the entity-entity interaction in the plurality of domains. Also, the cross domain recommendation system 108 recommends the one or more entities 102 to the new entity on the basis of similar entity interaction in the plurality of domains.

The cross domain recommendation system 108 is associated with the main server 110. In an embodiment of the present disclosure, the cross domain recommendation system 108 is located in the main server 110. In another embodiment of the present disclosure, the cross domain recommendation system 108 is located in the one or more communication devices 104. The main server 110 handles each operation and task performed by the cross domain recommendation system 108. The main server 110 stores one or more instructions for performing the various operations of the cross domain recommendation system 110.

The cross domain recommendation system 108 is associated with the administrator 112. The administrator 112 is any person or individual who monitors the working of the cross domain recommendation system 108 in real time. The administrator 112 monitors the working of the cross domain recommendation system 108 through the one or more communication devices. The one or more communication devices include a laptop, a desktop computer, a tablet, a personal digital assistant and the like.

It may be noted that in FIG. 1, the one or more entities 102 are associated with the one or more communication devices 104; however, a person skilled in the art would appreciate that there are more number of entities associated with more number of devices. Also, it may be noted that in FIG. 1, the cross domain recommendation system 108 recommends the one or more entities 102 to the one or more entities 102; however, a person skilled in the art would appreciate that the cross domain recommendation system 108 recommends the one or more entities 102 to more number of entities.

FIG. 2 illustrates a block diagram 200 of the cross domain recommendation system 108, in accordance with various embodiments of the present disclosure. It may be noted that to explain the system elements of the FIG. 2, references will be made to the system elements of the FIG. 1. The block diagram 200 illustrates one or more components of the cross domain recommendation system 108. The one or more components of the cross domain recommendation system 108 include a collecting module 202, a creation module 204, an analyzing module 206, a clustering module 208 and a ranking module 210. In addition, the one or more components include a recommendation module 212, a storing module 214, and an updating module 216. The above stated components of the cross domain recommendation system 108 enable the recommendation of the one or more entities 102 in the real time.

The one or more entities 102 access the application associated with the cross domain recommendation system 108 on the one or more communication devices 104. The cross domain recommendation system 108 registers the one or more entities 102 on the cross domain recommendation platform.

In an embodiment of the present disclosure, a computer program executed by a digital processing device creates or provided the cross-domain recommendation system 108. In another embodiment of the present disclosure, the cross-domain recommendation system 108 is provided by a web application accessed through a web browser. In yet another embodiment of the present disclosure, the cross-domain recommendation system 108 is provided by an extension, plug in, add in, or add on to a web browser executed on the one or more communication devices 104. In yet another embodiment of the present disclosure, the cross-domain recommendation system 108 is provided by a standalone application accessed through a web browser executed on the one or more communication devices 104. In yet another embodiment of the present disclosure, the cross-domain recommendation system 108 is provided by a mobile application executed on a mobile processing device. In an embodiment of the present disclosure, the cross-domain recommendation system 108 is Internet based system. In another embodiment of the present disclosure, the cross-domain recommendation system 108 is a cloud computing based system.

The cross domain recommendation system 108 includes a collecting module 202. The collecting module 202 collects a first set of data and a second set of data associated with the one or more entities 102 in real time. In addition, the first set of data is provided by the one or more entities 102 in the real time. The first set of data includes the demographic information associated with the one or more entities 102. Moreover, the demographic information includes name, age, gender, address, mobile number, qualification, a current location and an e-mail address of the one or more entities 102. In an embodiment of the present disclosure, the collecting module 202 collects the first set of data for registration of the one or more entities 102 on the various e-platforms. In another embodiment of the present disclosure, the first set of data includes likes and dislikes of the one or more entities 102. The likes and dislikes may be in the form of color, books, music and the like. In yet another embodiment of the present disclosure, the collecting module 202 collects the preferences of one or more entities 102 in at least one domain of the plurality of domains.

Further, the collecting module 202 collects the second set of data. The second set of data includes the data associated with the interaction of the one or more entities 102 with the one or more entities 102. In addition, the second set of data includes the data related to the reviews and ratings given by the one or more entities 102 for the one or more entities 102 in real time. Moreover, the second set of data includes the data related to the one or more entities 102 purchase history, entity viewing history, entity rating, entity reviews, subscribed entity, download entity. Furthermore, the second set of data includes the data collected by the different software and application used in one or more communication devices 104. In an embodiment of the present disclosure, the second set of data is collected by using software development kit in application and websites of the one or more entities 102. In another embodiment of the present disclosure, the second set of data includes the data collected from one or more external websites, application and social networking services to analyze the one or more entities 102 preference in each domain. In yet another embodiment of the present disclosure, the second set of data includes the data collected from other type of the one or more entities activities in real time.

The cross domain recommendation system 108 includes the creation module 204. The creation module 204 creates the model of the one or more entities 102 by using the first set of data and the second set of data. In an embodiment of the present disclosure, the cross domain recommendation system 108 creates the entity model of the one or more entities 102. The entity model is created based on the interaction of the one or more entities 102 with the one or more entities 102 in the plurality of domains. In another embodiment of the present disclosure, the creation module 204 creates the entity model of the one or more entities 102 for allowing the one or more entities 102 to define preferences in the plurality of domains.

The cross domain recommendation system 108 includes the analyzing module 206. The analyzing module 206 analyzes the first set of data and the second set of data with the help of one or more techniques. In addition, the analyzing module 206 analyzes the model of the entity model of the one or more entities 102 in real time. In an embodiment of the present disclosure, the analyzing module 206 analyzes the one or more reviews given by the one or more entities 102 in real time by using Natural language processing techniques. In an embodiment of the present disclosure, the analyzing module 206 analyzes the data on the basis of likes, dislikes, age, gender, purchase history, browsing history. In addition, the analyzing module 206 analyzes the data on the basis of ratings, reviews and preferences of the one or more entities 102 in the plurality of domains.

Further, the cross domain recommendation system 108 includes the classifying module 208. In an embodiment of the present disclosure, the classifying module 208 classifies each entity of the one or more entities 102 and the one or more entities 102 in one or more clusters. The one or more clusters are based on the analysis of the first set of data and the second set of data associated with the one or more entities 102. In an embodiment of the present disclosure, the one or more clusters are based on the entity model, attributes, likes, dislikes, preferences, gender and entity-entity interaction. In another embodiment of the present disclosure, the one or more clusters are based on the mapping of the one or more features. In an embodiment of the present disclosure, the one or more clusters of the one or more entities 102 with the one or more entities 102 are created by using clustering technique.

The cross domain recommendation system 108 includes ranking module 210. The ranking module 210 ranks the one or more entities 102 in each cluster of the one or more clusters. In an embodiment of the present disclosure, the ranking is based on a calculated distance between one or more values associated with the entity model and one or more feature values associated with the one or more entities 102. In another embodiment of the present disclosure, the ranking is based on one or more mapped features of the one or more entities 102 with the one or more entities preferences of the one or more entities 102. In yet another embodiment of the present disclosure, the ranking is based on the correlation of the one or more entities 102 with other entities. In an embodiment of the present disclosure, the ranking module 210 ranks the one or more clusters to recommend the one or more entities 102b with high accuracy.

The cross domain recommendation system 108 includes the recommendation module 212. The recommendation module 212 recommends the one or more entities 102 associated with at least one domain of the plurality of domains to the one or more entities 102 based on the ranking. In addition, the recommendation of the one or more entities 102 associated with at least one domain of the plurality of domains is based on the plurality of attributes. Furthermore, the recommendation of the one or more entities 102 associated with at least one domain of the plurality of domains is based on a search query made by the one or more entities 102. The recommendation module 212 recommends the one or more entities 102 in real time by applying an algorithm in one or more domains using preferences collected in the one or more other domains. Furthermore, the recommendation module 212 recommends the one or more entities 102 in the new domain based on the common features of the one or more entities 102 in the one or more clusters. Furthermore, the recommendation of the one or more entities 102 to the one or more new entities 102 is based on the knowledge of one or more entities 102 in other one or more domains.

In an example, the one or more domains includes but may not be limited to music, singers, movies, comedians, authors, TV shows, restaurants, bars, food, fashion brands, politicians, sports and vehicles. A film domain includes the topics film actors, film directors, action films, horror films, comedy films, and the like. In an example, the one or more entities 102 includes but may not be limited to shirts, shoes, t-shirts, movies, laptop, bottles, pen, chair, charger, fan, lights, mirror, jeans, mobiles, power bank, and the like.

In an embodiment of the present disclosure, the recommendation module 212 recommends a list of sort entities on the basis of assigned rank to the one or more entities 102. In another embodiment of the present disclosure, the recommendation module 212 recommends a list of entities to the one or more entities 102 on the basis of entity request in the plurality of domains. In yet another embodiment of the present disclosure, the recommendation module 212 recommends the one or more entities 102 to the one or more entities 102 on the basis of interaction. The recommendation based on the interaction includes interaction of other one or more entities 102 in the one or more clusters.

The cross domain recommendation system 108 includes a storing module 214. The storing module 214 stores the first set of data and the second set of data associated with the one or more entities 102. In addition, the storing module 214 stores the entity preferences of the one or more entities 102 in the one or more domains. Further, the storing module 214 stores the entity model of the one or more entities 102 and one or more clusters of the one or more entities 102. Also, the storing module 214 stores common features value, the recommended entity and the common feature value as the model of the one or more entities 102.

The cross domain recommendation system 108 includes an updating module 216. The updating module 216 updates the first set of data, the second set of data, and the entity model of the one or more entities. In addition, the updating module 216 updates the one or more clusters of the one or more entities 102 and common features value. Further, the updating module 216 updates the recommended entity and the common feature value as the model of the one or more entities 102. Furthermore, the updating module 216 updates the data in real time collected by the collection module 202.

### Example 1

The user A is a person sitting inside the room and wants to buy a t-shirt. The user A starts the laptop and connects the laptop with internet connection. The laptop is connected with the internet through a LAN cable. The user A open the web browser and then access a web based platform which provide the service of online clothes. The user A is new on that web based platform. The web based platform register the user A by taking some demographic information like name, age, gender, contact number, mail id and some other necessary information from the user A. In addition, the web based platform may ask the preferences of the user A related to the clothes like type, brand and color. In reference with the cross domain recommendation system 108, all the information of the user A is collected by collecting module 202. Once the user A gets registered on the web based platform, the web based platform provides the user A access to search manually from the list of clothes. The cross domain recommendation system 108 collects various information of the user A like interest of the user A while he search for the clothes. The collection of the information is done in background with the help of collection module 202. After collecting the information of the user A, the cross domain recommendation system 108 creates the profile of the user A with the help of Creation module 204. The profile of the user A includes all the information of the user A which helps in recommending the best results to the user A. The profile may include user preferences, user interest, likes, dislikes, reviews, ratings given by the user A to the one or more entities 102b.

After creation of the profile of the user A, the analyzing module 206 analyzes the information and extracts some attributes and features to recommend the results for which the user A searches. Further, the cross domain recommendation system 108 creates the cluster of the user A with similar one or more entities based on the similarities in data. The cross domain recommendation system 108 creates the cluster of the user A with the help of clustering module 208. In an example, the cross domain recommendation system 108 may create the cluster of the user A based on the similarities in gender, age, likes, preferences in one or more domains. After creating the cluster of the user A, the cross domain recommendation system 108 allows the user A to make a request for recommendation of t-shirts. In an embodiment of the present disclosure, the cross domain recommendation system 108 may automatically recommend the t-shirts to the user A, while the user A searches for the t-shirts in real time. Once the user A request for the recommendation, the cross domain recommendation system 108 ranked the list of the one or more entities 102b with the help of ranking module 210. After ranking of the one or more entities 102b, the cross domain recommendation system 108 recommends a list of the one or more entities 102b to the user A in a ranked manner. In an embodiment of the present disclosure, the cross domain recommendation system 108 recommends a list of other one or more entities 102b like bag, shirt, jeans and watch. In another embodiment of the present disclosure, the cross domain recommendation system 108 may recommends on the basis of other similar one or more entities. In an example, user A is a male having age of 45 year then the cross domain recommendation system 108 can recommend the t-shirts to the user A based on the ratings and reviews given by the similar male users having similar age.

### Example 2

A user X is looking for a science fiction novel on any web based platform. The domain for the novel corresponds to book. The user X access the other web based platform which have different domains like movies, songs and the like. On the basis of user X preferences in other domains, the cross domain recommendation system 108 recommends one or more science fiction novels to the user X. In an embodiment of the present disclosure, the recommendation of the one or more science fiction novels may be in the form of advertisement. In another embodiment of the present disclosure, the recommendation of the one or more novels may be on the same platform, websites or app.

### Example 3

The user Y is looking for the shoes on the mobile application. The application takes one or more user Y preferences for shoes. The user Y preferences may include color, brand, and type of the shoes. In an embodiment of the present disclosure, the application may recommend a list of shoes based on the user Y preferences. In addition, the mobile application may recommend other one or more entities 102b like t-shirts, goggles, shirts and jeans to the user Y based on the user preferences in shoes. The recommendation of the other one or more entities 102b may be through ads on the mobile application.

### Example 4

The user Z is new on the web based platform and looking for an interesting movie. While registering the user Z, the web based platform asks for some preferences of the user Z in the movie domain. In an example, the preferences may be in the form of actor, actress, comedy, horror, action, director and language. The cross domain recommendation system 108 analyzes the user Z preferences and identifies the similar one or more entities having similar preferences in that domain. In an embodiment of the present disclosure, the cross domain recommendation system 108 recommends the list of movies to the user Z based on the data given by the similar entities. The data includes review, rating, most viewed and most liked.

### Example 5

A user M downloads a mobile application related to the recommendation system from an online application store and installs it in the smartphone owned by the user M. The user M first register himself on the application by providing some necessary information like name, age, contact number, email id. The mobile application asks the user M to define at least five preferences in each of the three domains from the plurality of domains. In an example, the plurality of domains may include TV shows, Fashion brands, movies, songs, travel destinations, books and music. The user M requests a recommendation for games based on the above defined preferences. The user M presented with a list of recommended games in descending strength. The rank provided to each recommended game by the application decides the strength of recommendation.

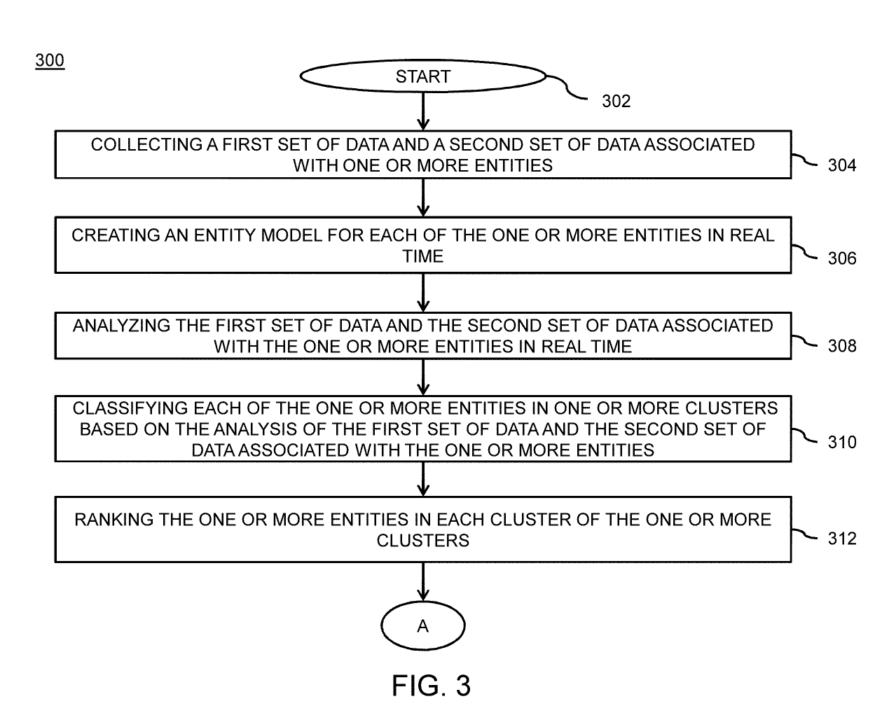

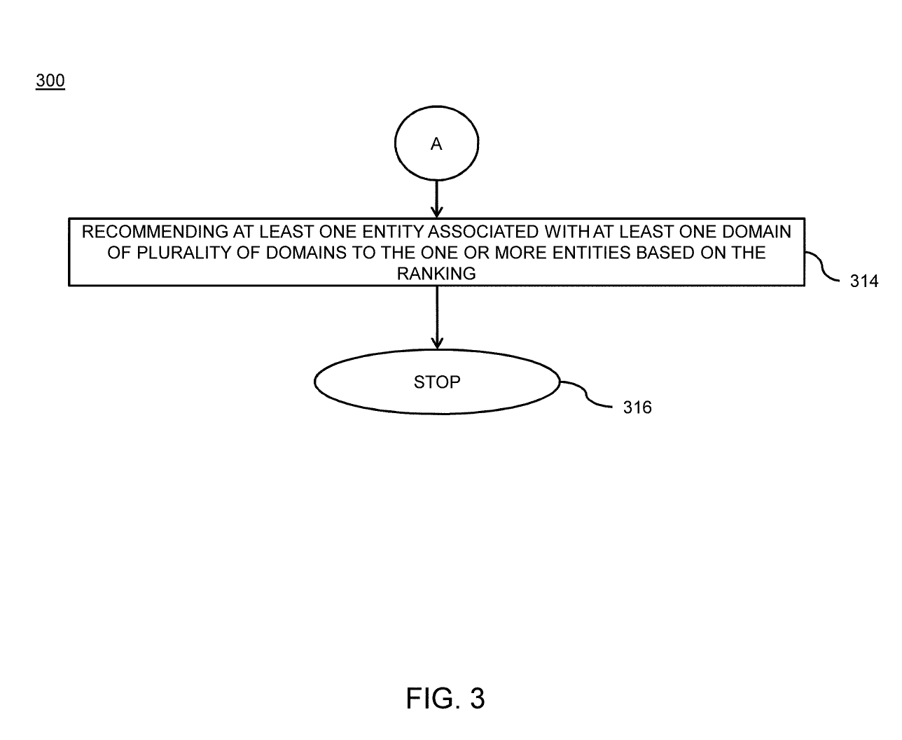

FIG. 3 illustrates a flow chart 300 for real time recommendation of one or more entities 102 to one or more entities 102 in a targeted domain in accordance with various embodiments of the present disclosure. It may be noted that to explain the process steps of flowchart 300, references will be made to the system elements of FIG. 1 and FIG. 2. It may also be noted that the flowchart 300 may have lesser or more number of steps.

The flowchart 300 initiates at step 302. Following step 302, at step 304, the cross domain recommendation system 108 collects a first set of data and a second set of data associated with one or more entities 102. At step 306, the cross domain recommendation system 108 creates an entity model for each of the one or more entities 102 in real time. At step 308, the cross domain recommendation system 108 analyse the first set of data and the second set of data associated with the one or more entities 102 in real time. At step 310, the cross domain recommendation system 108 classifies each of the one or more entities in the one or more clusters based on the analysis of the first set of data and the second set of data. The first set of data and the second set of data are associated with the one or more entities 102. At step 312, the cross domain recommendation system 108 ranks the one or more entities in each cluster of the one or more clusters. The ranking is based on at least one of a calculated distance between one or more values associated with the entity model and one or more feature values associated with the one or more entities. In addition, the ranking is based on the one or more mapped features of the one or more entities 102 with the one or more entity preferences of the one or more entities 102. Further, the ranking is based on the correlation of the one or more entities 102 with other entities. At step 314, the cross domain recommendation system 108 recommends at least one entity associated with at least one domain of the plurality of domains to the one or more entities 102 based on the ranking. The flow chart 300 terminates at step 316.

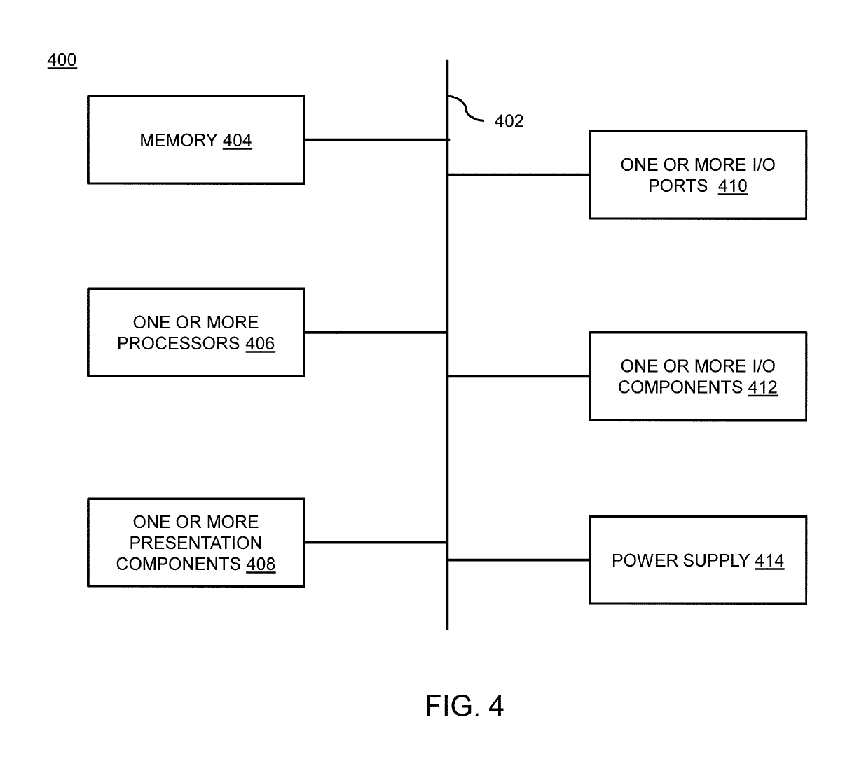

FIG. 4 illustrates a block diagram of a computing device 400, in accordance with various embodiments of the present disclosure. The computing device 400 includes a bus 402 that directly or indirectly couples the following devices: memory 404, one or more processors 406, one or more presentation components 408, one or more input/output (I/O) ports 410, one or more input/output components 412, and an illustrative power supply 414. The bus 402 represents what may be one or more busses (such as an address bus, data bus, or combination thereof). Although the various blocks of FIG. 4 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 4 is merely illustrative of an exemplary computing device 400 that can be used in connection with one or more embodiments of the present invention. Distinction is not made between such categories as “workstation,” “server,” “laptop,” “hand-held device,” etc., as all are contemplated within the scope of FIG. 4 and reference to “computing device.”

The computing device 400 typically includes a variety of computer-readable media. The computer-readable media can be any available media that can be accessed by the computing device 400 and includes both volatile and nonvolatile media, removable and non-removable media. By way of example, and not limitation, the computer-readable media may comprise computer storage media and communication media. The computer storage media includes volatile and nonvolatile, removable and non-removable media implemented in any method or technology for storage of information such as computer-readable instructions, data structures, program modules or other data. The computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 400. The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 404 includes computer-storage media in the form of volatile and/or nonvolatile memory. The memory 404 may be removable, non-removable, or a combination thereof. Exemplary hardware devices include solid-state memory, hard drives, optical-disc drives, etc. The computing device 400 includes one or more processors that read data from the one or more entities 102 such as memory 404 or I/O components 412. The one or more presentation components 408 present data indications to a user or other device. Exemplary presentation components include a display device, speaker, printing component, vibrating component, etc. The one or more I/O ports 410 allow the computing device 400 to be logically coupled to other devices including the one or more I/O components 412, some of which may be built in. Illustrative components include a microphone, joystick, game pad, satellite dish, scanner, printer, wireless device, etc.

What is claimed:

1. A computer-implemented method for real time recommendation of at least one entity of one or more entities to another entity of the one or more entities in a new domain by using one or more profiles from a plurality of domains, the computer-implemented method comprising:
collecting, at a cross domain recommendation system with a processor, a first set of data and a second set of data associated with the one or more entities, wherein the first set of data comprises demographic information of the one or more entities and the second set of data comprises information associated with interaction between the at least one entity of the one or more entities with another entity of the one or more entities, wherein the first set of data and the second set of data being collected in real time;
creating, at the cross domain recommendation system with the processor, an entity model for each of the one or more entities in real time, wherein the entity model of the one or more entities is created based on the first set of data and the second set of data associated with the one or more entities, wherein the entity model being created for defining a set of activities performed by each of the one or more entities based on the interaction with between the one or more entities;
analyzing, at the cross domain recommendation system with the processor, the first set of data and the second set of data associated with the one or more entities in real time, wherein the analyzing being done using one or more techniques and machine learning algorithms to determine a correlation in the at least one or more entities and one or more entity preferences associated with the one or more entities in each of the plurality of domains;
classifying, at the cross domain recommendation system with the processor, each of the one or more entities in one or more clusters based on the analysis of the first set of data and the second set of data associated with the one or more entities, wherein the one or more clusters of the one or more entities being created in real time by using one or more clustering techniques;
ranking, at the cross domain recommendation system with the processor, the one or more entities in each cluster of the one or more clusters based on at least one of a calculated distance between one or more values associated with the entity model and one or more feature values associated with the one or more entities, one or more mapped features of the one or more entities with the one or more entity preferences of the one or more entities and correlation of the one or more entities with other entities, wherein the ranking being done in real time; and
recommending, at the cross domain recommendation system with the processor, the at least one entity associated with at least one domain of the plurality of domains to the one or more entities based on the ranking, wherein the at least one entity recommended to the one or more entities being associated with the at least one domain different than the one or more domains with which the one or more entities interact in the real time, wherein the recommendation of the at least one entity to the one or more entities being done based on a request by the entity of the one or more entities for receiving recommendation for at least one other entity of the one or more entities.

2. The computer implemented method as recited in claim 1, further comprising storing, at the cross domain recommendation system with the processor, the first set of data, the second set of data, the entity model of the one or more entities, the one or more clusters of the one or more entities and common features value, the recommended entity and the common feature value as the model of the one or more entities, wherein the storing being done in real time.

3. The computer implemented method as recited in claim 1, further comprising updating, at the cross domain recommendation system with the processor, the first set of data, the second set of data, the entity model of the one or more entities, the one or more clusters of the one or more entities and common features value, wherein the updating being done in real time.

4. The computer implemented method as recited in claim 1, wherein the entity comprises at least one of one or more e-services, one or more products the one or more entities and one or more businesses.

5. The computer implemented method as recited in claim 1, wherein the first set of data comprises name, age, gender, address, contact number, e-mail address, qualification, and preferences of the one or more entities in one or more domains.

6. The computer implemented method as recited in claim 1, wherein the second set of data comprises one or more entity purchase histories, entity viewing histories, entity ratings, entity reviews, entity subscribed and entity downloads.

7. The computer implemented method as recited in claim 1, wherein the one or more techniques comprises natural language processing technique to analyze the reviews, tokenization techniques to extract the information and the machine learning algorithms.

8. The computer implemented method as recited in claim 1, wherein the cluster of the one or more entities is being created with one or more features of the one or more entities with which the one or more entities interact.

9. A computer system comprising:
one or more processors; and
a memory coupled to the one or more processors, the memory for storing instructions which, when executed by the one or more processors cause the one or more processors to perform a method for real time recommendation of at least one entity of one or more entities to another entity of the one or more entities in a new domain by using one or more profiles from a plurality of domains, the method comprising:
collecting, at a cross domain recommendation system, a first set of data and a second set of data associated with the one or more entities, wherein the first set of data comprises demographic information of the one or more entities and the second set of data comprises information associated with interaction between the at least one entity of the one or more entities with another entity of the one or more entities, wherein the first set of data and the second set of data being collected in real time;
creating, at the cross domain recommendation system, an entity model for each of the one or more entities in the real time, wherein the entity model of the one or more entities being created based on the first set of data and the second set of data associated with the one or more entities, wherein the entity model being created for defining a set of activities performed by each of the one or more entities based on the interaction with between the one or more entities;
analyzing, at the cross domain recommendation system, the first set of data and the second set of data associated with the one or more entities in the real time, wherein the analyzing being done using one or more techniques and machine learning algorithms to determine a correlation in the at least one or more entities and one or more entity preferences associated with the one or more entities in each of the plurality of domains;
classifying, at the cross domain recommendation system, each of the one or more entities in one or more clusters based on the analysis of the first set of data and the second set of data associated with the one or more entities, wherein the one or more clusters of the one or more entities is being created in real time by using one or more clustering techniques;
ranking, at the cross domain recommendation system, the one or more entities in each cluster of the one or more clusters based on at least one of a calculated distance between one or more values associated with the entity model and one or more feature values associated with the one or more entities one or more mapped features of the one or more entities with the one or more entity preferences of the one or more entities and correlation of the one or more entities with other entities, wherein the ranking being done in real time; and
recommending, at the cross domain recommendation system, at least one entity associated with at least one domain of the plurality of domains to the one or more entities based on the ranking, wherein the at least one entity recommended to the one or more entities being associated with the at least one domain different than one or more domains with which the one or more entities interact in real time, wherein the recommendation of the at least one entity to the one or more entities being done based on a request by the entity of the one or more entities for receiving recommendation for at least one other entity of the one or more entities.

10. The computer system as recited in claim 9, further comprising storing, at the cross domain recommendation system, the first set of data, the second set of data, the entity model of the one or more entities, the one or more clusters of the one or more entities and common features value, the recommended entity and the common feature value as the model of the one or more entities, wherein the storing being done in real time.

11. The computer system as recited in claim 9, further comprising updating, at the cross domain recommendation system, the first set of data, the second set of data, the entity model of the one or more entities, the one or more clusters of the one or more entities and common features value, wherein the updating being done in real time.

12. The computer system as recited in claim 9, wherein the entity comprises at least one of one or more e-services, one or more products, the one or more entities and one or more businesses.

13. The computer system as recited in claim 9, wherein the first set of data comprises name, age, gender, address, contact number, e-mail address, qualification and preferences of the one or more entities in one or more domains.

14. The computer system as recited in claim 9, wherein the second set of data comprises one or more entity purchase histories, entity viewing histories, entity ratings, entity reviews, entity subscribed and entity downloads.

15. The computer system as recited in claim 9, wherein the one or more techniques comprises natural language processing technique to analyze the reviews, tokenization techniques to extract the information and the machine learning algorithms.

16. The computer system as recited in claim 9, wherein the cluster of the one or more entities is created with one or more features of the one or more entities with which the one or more entities interact.

17. A computer-readable storage medium encoding computer executable instructions that, when executed by at least one processor, performs a method for real time recommendation of at least one entity of one or more entities to another entity of the one or more entities in a new domain by using one or more profiles from a plurality of domains, the method comprising:
collecting, at a computing device, a first set of data and a second set of data associated with the one or more entities, wherein the first set of data comprises demographic information of the one or more entities and the second set of data comprises information associated with interaction between the at least one entity of the one or more entities with another entity of the one or more entities, wherein the first set of data and the second set of data being collected in real time;
creating, at the computing device, an entity model for each of the one or more entities in real time, wherein the entity model of the one or more entities being created based on the first set of data and the second set of data associated with the one or more entities, wherein the entity model being created for defining a set of activities performed by each of the one or more entities based on the interaction with between the one or more entities;
analyzing, at the computing device, the first set of data and the second set of data associated with the one or more entities in real time, wherein the analyzing being done using one or more techniques and machine learning algorithms to determine a correlation in the at least one or more entities and one or more entity preferences associated with the one or more entities in each of the plurality of domains;
classifying, at the computing device, each of the one or more entities in one or more clusters based on the analysis of the first set of data and the second set of data associated with the one or more entities, wherein the one or more clusters of the one or more entities is being created in real time by using one or more clustering techniques;
ranking, at the computing device, the one or more entities in each cluster of the one or more clusters based on at least one of a calculated distance between one or more values associated with the entity model and one or more feature values associated with the one or more entities, one or more mapped features of the one or more entities with the one or more entity preferences of the one or more entities and correlation of the one or more entities with other entities, wherein the ranking being done in real time; and
recommending, at the computing device, at least one entity associated with at least one domain of the plurality of domains to the one or more entities based on the ranking, wherein the at least one entity recommended to the one or more entities being associated with the at least one domain different than one or more domains with which the one or more entities interact in real time, wherein the recommendation of the at least one entity to the one or more entities being done based on a request by the entity of the one or more entities for receiving recommendation for at least one other entity of the one or more entities.
